(19) United States
(12) Patent Application Publication
(10) Pub. No.: US 2009/0034291 A1
(43) Pub. Date: Feb. 5, 2009

(54) BACKLIGHT AND DISPLAY DEVICE INCLUDING THE SAME

(75) Inventor: Nobuyuki Nakamura, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 11/817,542

(22) PCT Filed: Jan. 27, 2006
(86) PCT No.: PCT/JP2006/301355

§ 371 Date: Aug. 31, 2007

(30) Foreign Application Priority Data
Mar. 18, 2005 (JP) 2005-079837

(51) Int. Cl. F21V 8/00

(52) U.S. Cl. 362/613; 362/97.2

(57) ABSTRACT

A backlight includes at least one first light source, and a light guide arranged to receive light from the at least one first light source on a side surface thereof and to emit planar light from a principle surface thereof substantially perpendicular to the side surface. Each of the at least one first light source includes a first elongated light emitting member and a second elongated light emitting member arranged substantially parallel to the first light emitting member. The second light emitting member is different in length in the lengthwise direction from the first light emitting member.

### BACKGROUND OF THE INVENTION

1. Field of the Invention

The present invention relates to a backlight and a display device including the same.

2. Description of the Related Art

In recent years, there has been a growing demand for mobile devices such as laptop computers. In accordance with such a trend, downsizing of display devices (e.g., liquid crystal display devices), in particular, narrowing of their frames, has been an important issue to be addressed.

FIG. 15 is a sectional view illustrating the structure of a conventional liquid crystal display device 100 with reduced size and narrowed frame.

The liquid crystal display device 100 has a backlight 110, a front chassis 121, a liquid crystal display panel 122 and a back chassis 120. The backlight 110 includes lamps 111, rubber holders 112, lamp holders 113, harnesses 114, a transparent light guide 116, a reflective sheet 117, a prism sheet 118 and a diffusive sheet 119. In the backlight 110, the transparent light guide 116 is in the form of a plate having a uniform thickness and two lamps 111 are arranged to face each of a pair of opposed side surfaces of the transparent light guide 116. The two lamps 111 arranged to face the same side surface of the transparent light guide 116 have substantially the same length in the lengthwise direction.

Patent Literature: Japanese Unexamined Patent Publication No. H09-259625

FIGS. 16A to 16C are diagrams illustrating a distribution of luminance of the backlight 110. More specifically, FIGS. 16A and 16C are diagrams of the backlight 110 viewed from the side and FIG. 16B is a diagram of the backlight 110 viewed from the principle surface (light emitting surface).

As shown in FIGS. 16A to 16C, the lamp holders 113 and the transparent light guide 116 of the backlight 110 have substantially the same length for the purpose of reducing the size and narrowing the frame of the liquid crystal display device 100. Therefore, a light emitting region of the lamps 111 placed in the lamp holders 113 is shorter than the transparent light guide 116 and light from the lamps 111 does not directly enter the corners 116a of the transparent light guide 116. As a result, luminance of the corners 116a of the transparent light guide 116 is lower than that of a center portion 116b of the transparent light guide 116 to which the light from the lamps 111 directly enters.

In the backlight 110, the pair of lamps 111 arranged near the same side surface of the transparent light guide 116 are configured to have substantially the same length in order to achieve high luminance. Therefore, the corners 116a and the center portion 116b are significantly different in luminance. As a result, a boundary between the corners 116a and the center portion 116b is emphasized. That is, it is difficult for the conventional backlight 110 to emit high quality planar light with less noticeable luminance variations. Thus, the conventional liquid crystal display device 100 has a problem of difficulty in high quality image display.

### SUMMARY OF THE INVENTION

In order to overcome the problems described above, preferred embodiments of the present invention provide a backlight that is capable of emitting high quality planar light with less noticeable luminance variations, and provide a liquid crystal display device capable of producing high quality image with less noticeable luminance variations.

The preferred embodiments of the present invention are described with reference to the conventional liquid crystal display device 100 taken as an example. However, the preferred embodiments of the present invention are also applicable to various display devices having different display medium layers.

A backlight according to a first preferred embodiment of the present invention includes: one or more first narrow light sources; and a light emitting plate arranged to receive light from the one or more first light sources on a side surface thereof and to emit planar light from a principle surface thereof that is substantially perpendicular to the side surface. Each of the one or more first light sources includes a first elongated light emitting member and a second elongated light emitting member arranged substantially parallel to the first light emitting member. The second light emitting member is different in length in the lengthwise direction from the first light emitting member. The light emitting plate may be a light guide.

With respect to the first backlight according to the first preferred embodiment of the present invention, a center portion of the first light source is constituted of both of the first and second light emitting members, while ends of the first light source are constituted of either one of the first and second light emitting members. Therefore, luminance of the ends of the first light source is lower than that of the center portion of the first light source. Accordingly, a low luminance portion into which light from the first light source does not directly enter, an intermediate luminance portion into which light from either one of the first and second light emitting members directly enters and a high luminance portion into which light from both of the first and second light emitting members directly enters are arranged sequentially in this order on the light emitting plate. Therefore, with the first backlight according to the first preferred embodiment of the present invention, a boundary between the low luminance portion and the high luminance portion is blurred and high quality planar light is emitted with less noticeable luminance variations.

In the present specification, there is no particular limitation on the “light source”. For example, the “light source” may be a lamp (fluorescent tube), an organic electroluminescence element, an inorganic electroluminescence element, a plasma light emitting element, a field emission element or a light emitting diode (LED).

When the light emitting plate is rectangular, it is preferable to arrange the first light source along a side surface of the light emitting plate corresponding to the long side of the principle surface of the light emitting plate. With this configuration, the first light source is relatively long and the backlight is achieved with high luminance.

A backlight according to the first preferred embodiment of the present invention may further include a wire connected to an end of the first light emitting member to apply a voltage to the first light emitting member and the first light emitting member may be longer than the second light emitting member in the lengthwise direction. With this configuration, the wire is preferably routed toward the second light emitting member.

A backlight according to the first preferred embodiment of the present invention may further include one or more second narrow light sources for emitting light to a side surface of the light emitting plate opposite the side surface receiving the light from the one or more first light sources. With this configuration, the backlight is achieved with high luminance. Each of the one or more second narrow light sources preferably includes a third elongated light emitting member and a fourth elongated light emitting member arranged substantially parallel to the third light emitting member and different in length in the lengthwise direction from the third light emitting member.

A backlight according to a second preferred embodiment of the present invention includes: one or more first narrow light sources; and a light emitting plate arranged to receive light from the one or more first light sources on a back surface thereof and emit planar light from a principle surface thereof opposite the back surface. Each of the one or more first light sources includes a first elongated light emitting member and a second elongated light emitting member arranged substantially parallel to the first light emitting member. The second light emitting member is different in length in the lengthwise direction from the first light emitting member. The light emitting plate may be a diffusive plate for diffusing and transmitting the light from the first light source received on the back surface toward the principle surface.

With respect to the backlight according to a second preferred embodiment of the present invention, a center portion of the first light source is constituted of both of the first and second light emitting members, while ends of the first light source are constituted of either one of the first and second light emitting members. Therefore, luminance of the ends of the first light source is lower than that of the center portion of the first light source. Accordingly, a low luminance portion into which light from the first light source does not directly enter, an intermediate luminance portion into which light from either one of the first and second light emitting members directly enters and a high luminance portion into which light from both of the first and second light emitting members directly enters are arranged sequentially in this order on the light emitting plate. Therefore, with the backlight according to the second preferred embodiment of the present invention, a boundary between the low luminance portion and the high luminance portion is blurred and high quality planar light is emitted with less noticeable luminance variations.

With respect to the backlight according to the first or second preferred embodiments of the present invention, the first light emitting member may be arranged such that one end of the first light emitting member and one end of the second light emitting member are aligned in the extending direction of the first light emitting member and the other end of the first light emitting member and the other end of the second light emitting member are misaligned in the extending direction of the first light emitting member. Further, the backlight according to the first and second preferred embodiments of the present invention may include: first wires connected to the ends of the first light emitting member to apply a voltage to the first light emitting member; and second wires connected to the ends of the second light emitting member to apply a voltage to the second light emitting member. In this case, it is preferable that the first wire connected to the one end of the first light emitting member and the second wire connected to the one end of the second light emitting member are connected to each other. With this configuration, the backlight with a simple structure is manufactured in an easy manner. If the first and second light emitting members are elongated lamps (fluorescent tubes), respectively, the first wire electrically connected to the COLD end of the first light emitting member and the second wire electrically connected to the COLD end of the second light emitting member are preferably connected to each other because a voltage applied to the COLD ends is lower than that applied to HOT ends.

With respect to the backlight according to the first and second preferred embodiments of the present invention, an end of the first light emitting member and an end of the second light emitting member may be coupled to each other such that the first light source is U-shaped.

With this configuration, the luminance of the ends of the first light source constituted of the first or second light emitting member is lower than that of the other portion of the first light source. Accordingly, a low luminance portion, an intermediate luminance portion and a high luminance portion are sequentially provided in this order on the light emitting plate. Therefore, a boundary between the low luminance portion and the high luminance portion is blurred and high quality planar light is emitted with less noticeable luminance variations.

With respect to the backlight according to the first and second preferred embodiments of the present invention, the first light emitting member and the second light emitting member may be arranged in the thickness direction of the light emitting plate.

With respect to the backlight according to the first and second preferred embodiments of the present invention, the first light emitting member and the second light emitting member may be arranged in the plane direction of the light emitting plate.

A display device according to the first preferred embodiment of the present invention includes a backlight for emitting planar light and a display medium layer through which the planar light transmits. The backlight preferably includes one or more first narrow light sources and a light emitting plate arranged to receive light from the one or more first light sources on a side surface thereof and emit planar light from a principle surface thereof perpendicular to the side surface. Each of the one or more first light sources includes a first elongated light emitting member and a second elongated light emitting member arranged substantially parallel to the first light emitting member. The second light emitting member is different in length in the lengthwise direction from the first light emitting member.

With respect to the display device according to the first preferred embodiment of the present invention, a center portion of the first light source is constituted of both of the first and second light emitting members, while ends of the first light source are constituted of either one of the first and second light emitting members. Therefore, luminance of the ends of the first light source is lower than that of the center portion of the first light source. Accordingly, a low luminance portion into which light from the first light source does not directly enter, an intermediate luminance portion into which light from either one of the first and second light emitting members directly enters and a high luminance portion into which light from both of the first and second light emitting members directly enters are arranged sequentially in this order on the light emitting plate. Therefore, with this backlight, a boundary between the low luminance portion and the high luminance portion is blurred and high quality planar light is emitted with less noticeable luminance variations. Thus, the display device according to the first preferred embodiment of the present invention produces high quality image with less noticeable luminance variations.

In the present specification, the “display medium layer” signifies a layer which varies optical transmittance or optical reflectance in response to a potential difference between electrodes facing each other, or alternatively, a layer which emits light spontaneously in response to a current flowing between the electrodes facing each other. Examples of the display medium layer may include a liquid crystal layer, an inorganic or organic electroluminescence layer, a light emitting gaseous layer, an electrophoretic layer, an electrochromic layer and the like.

With respect to the display device according to the first preferred embodiment of the present invention, the backlight may further include a wire connected to an end of the first light emitting member to apply a voltage to the first light emitting member and the first light emitting member may be longer than the second light emitting member in the lengthwise direction. With this configuration, the wire is preferably routed toward the second light emitting member.

With respect to the display device according to the first preferred embodiment of the present invention, the backlight may further include one or more second narrow light sources for emitting light to a side surface of the light emitting plate opposite the side surface receiving the light from the one or more first light sources. Each of the one or more second light sources preferably includes a third elongated light emitting member and a fourth elongated light emitting member arranged substantially parallel to the third light emitting member and different in length in the lengthwise direction from the third light emitting member.

A display device according to the second preferred embodiment of the present invention includes a backlight for emitting planar light and a display medium layer through which the planar light transmits. With respect to the display device according to the second preferred embodiment of the present invention, the backlight includes one or more first narrow light sources and a light emitting plate arranged to receive light from the one or more first light sources on a back surface thereof and emit the planar light from a principle surface thereof opposite the back surface. Each of the one or more first light sources includes a first elongated light emitting member and a second elongated light emitting member arranged substantially parallel to the first light emitting member. The second light emitting member is different in length in the lengthwise direction from the first light emitting member.

With respect to the display device according to the second preferred embodiment of the present invention, a center portion of the first light source is constituted of both of the first and second light emitting members, while ends of the first light source are constituted of either one of the first and second light emitting members. Therefore, luminance of the ends of the first light source is lower than that of the center portion of the first light source. Accordingly, a low luminance portion into which light from the first light source does not directly enter, an intermediate luminance portion into which light from either one of the first and second light emitting members directly enters and a high luminance portion into which light from both of the first and second light emitting members directly enters are arranged sequentially in this order on the light emitting plate. Therefore, with this backlight, a boundary between the low luminance portion and the high luminance portion is blurred and high quality planar light is emitted with less noticeable luminance variations. Thus, the display device according to the second preferred embodiment of the present invention produces high quality image with less noticeable luminance variations.

With respect to the display device according to the first and second preferred embodiments of the present invention, the first light emitting member may be arranged such that one end of the first light emitting member and one end of the second light emitting member are aligned in the extending direction of the first light emitting member and the other end of the first light emitting member and the other end of the second light emitting member are misaligned in the extending direction of the first light emitting member. The backlight may further include a first wire connected to the ends of the first light emitting member to apply a voltage to the first light emitting member and a second wire connected to the ends of the second light emitting member to apply a voltage to the second light emitting member. The first wire connected to the one end of the first light emitting member and the second wire connected to the one end of the second light emitting member may be connected to each other.

With respect to the display device according to the first and second preferred embodiments of the present invention, an end of the first light emitting member and an end of the second light emitting member may be coupled to each other such that the first light source is U-shaped.

With respect to the display device according to the first and second preferred embodiments of the present invention, the first light emitting member and the second light emitting member may be arranged in the thickness direction of the light emitting plate.

With respect to the display device according to the first and second preferred embodiments of the present invention, the first light emitting member and the second light emitting member may be arranged in the plane direction of the light emitting plate.

As described above, a backlight according to various preferred embodiments of the present invention makes it possible to emit high quality planar light with less noticeable luminance variations. Further, the display device according to various preferred embodiments of the present invention makes it possible to produce high quality image with less noticeable luminance variations.

Other features, elements, steps, characteristics and advantages of the present invention will become more apparent from the following detailed description of preferred embodiments with reference to the attached drawings.

### BRIEF DESCRIPTION OF DRAWINGS

FIG. 1 is a sectional view illustrating the structure of a liquid crystal display device according to a first preferred embodiment of the present invention.

FIG. 2 is a schematic sectional view taken along the line II-II shown in FIG. 1.

FIG. 3 is a sectional view illustrating the structure including first and second fluorescent tubes of the same length and a first wire routed toward the second fluorescent tube.

FIGS. 4A to 4C are diagrams illustrating a distribution of luminance of a backlight.

FIG. 5 is a schematic sectional view illustrating the structure of a liquid crystal display device according to a second preferred embodiment of the present invention.

FIGS. 6A to 6C are diagrams illustrating a distribution of luminance of a backlight of the liquid crystal display device.

FIG. 7 is a schematic sectional view illustrating the structure of a liquid crystal display device according to a third preferred embodiment of the present invention.

FIG. 8 is a schematic sectional view illustrating the structure of a liquid crystal display device according to a fourth preferred embodiment of the present invention.

FIG. 9 is a schematic sectional view illustrating the structure of a liquid crystal display device according to a fifth preferred embodiment of the present invention.

FIG. 10 is a schematic sectional view taken along the line X-X shown in FIG. 9.

FIG. 11A to 11C are diagrams illustrating a distribution of luminance of a backlight.

FIG. 12 is a sectional view of a liquid crystal display device according to a sixth preferred embodiment of the present invention.

FIG. 13 is a plan view of a light source unit illustrating the structure of a first light source.

FIG. 14 is a diagram illustrating a distribution of luminance of a backlight.

FIG. 15 is a sectional view illustrating the structure of a conventional liquid crystal display device having a reduced size and narrowed frame.

FIGS. 16A to 16C are diagrams illustrating a distribution of luminance of a backlight.

### DETAILED DESCRIPTION OF PREFERRED EMBODIMENTS

Hereinafter, preferred embodiments of the present invention will be explained in detail with reference to the drawings.

### First Preferred Embodiment

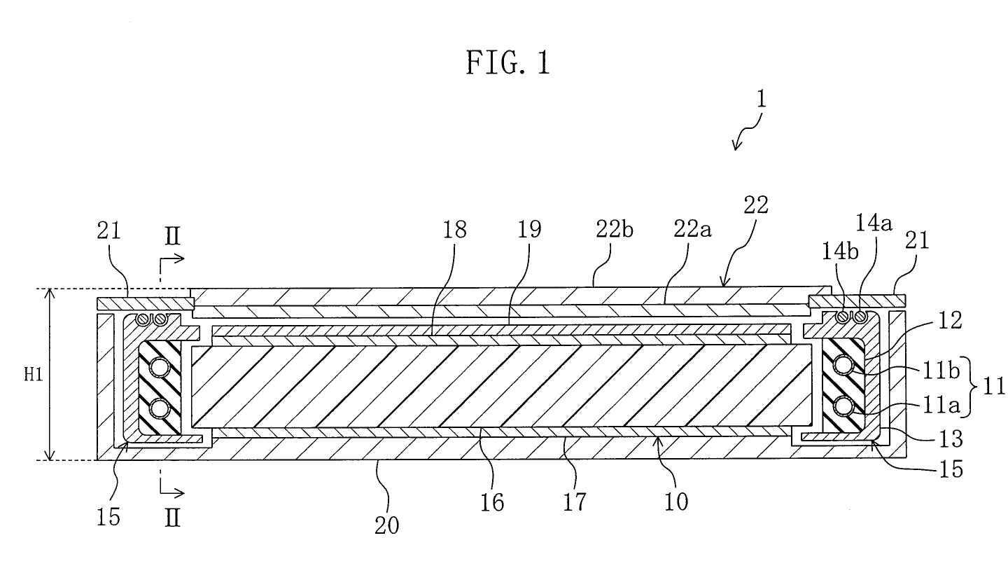

FIG. 1 is a sectional view illustrating the structure of a liquid crystal display device 1 according to a first preferred embodiment of the present invention.

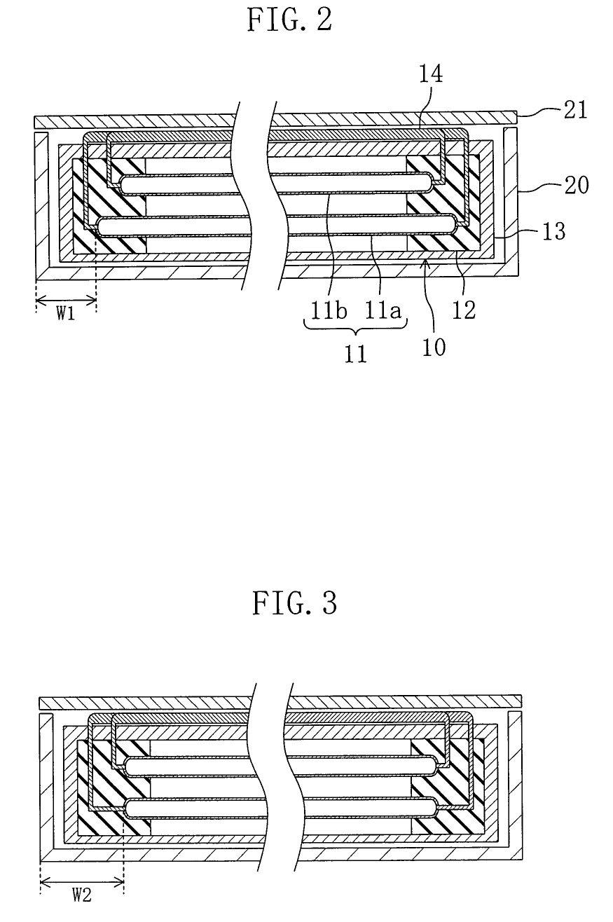

FIG. 2 is a schematic sectional view taken along the line II-II shown in FIG. 1.

The liquid crystal display device 1 includes a backlight 10, a liquid crystal display panel 22, a back chassis 20 and a front chassis 21. The liquid crystal display panel 22 includes a liquid crystal layer (not shown) and a pair of substrates 22a and 22b sandwiching the liquid crystal layer. Electrodes (not shown) for applying a voltage to the liquid crystal layer are formed on the surfaces of the substrates 22a and 22b facing the liquid crystal layer, respectively. The liquid crystal display panel 22 is arranged to face a light emitting surface of the backlight 10. The back chassis 20 is arranged on the back of the backlight 10. The front chassis 21 holds the periphery of the liquid crystal display panel 22.

The backlight 10 includes a light guide 16 as a light emitting plate and two light source units 15 for emitting light onto the side surfaces of the light guide 16, respectively. The two light source units 15 are arranged to face each other with the light guide 16 interposed therebetween.

Each of the light source units 15 includes a first light source 11, a pair of rubber holders 12 and a lamp holder 13. The first light source 11 includes a first fluorescent tube 11a as a first light emitting member and a second fluorescent tube 11b as a second light emitting member. Each of the rubber holders 12 secures the ends of the first and second fluorescent tubes 11a and 11b. The lamp holder 13 secures the entirety of the first and second fluorescent tubes 11a and 11b with their ends secured by the rubber holders 12.

The surface of the lamp holder 13 facing the first light source 11 may be light-reflective. If the surface of the lamp holder 13 facing the first light source 11 is light-reflective, light emitted from the first light source 11 to the lamp holder 13 is reflected on the light-reflective surface of the lamp holder 13 to the light guide 16. As a result, the light emitted from the first light source 11 enters the light guide 16 at high efficiency (i.e., light use efficiency is improved).

The light emitted from the first light source 11 enters the light guide 16 through the side surface of the light guide 16. A reflective sheet 17 is provided on the back of the light guide 16 such that the light entered the light guide 16 is guided to the principle surface (light emitting surface). The guided light is then emitted out of the principle surface as planar light. The planar light emitted from the principle surface of the light guide 16 is gathered and diffused into the liquid crystal display panel 22 by a prism sheet 18 and a diffusive sheet 19 stacked on the principle surface of the light guide 16.

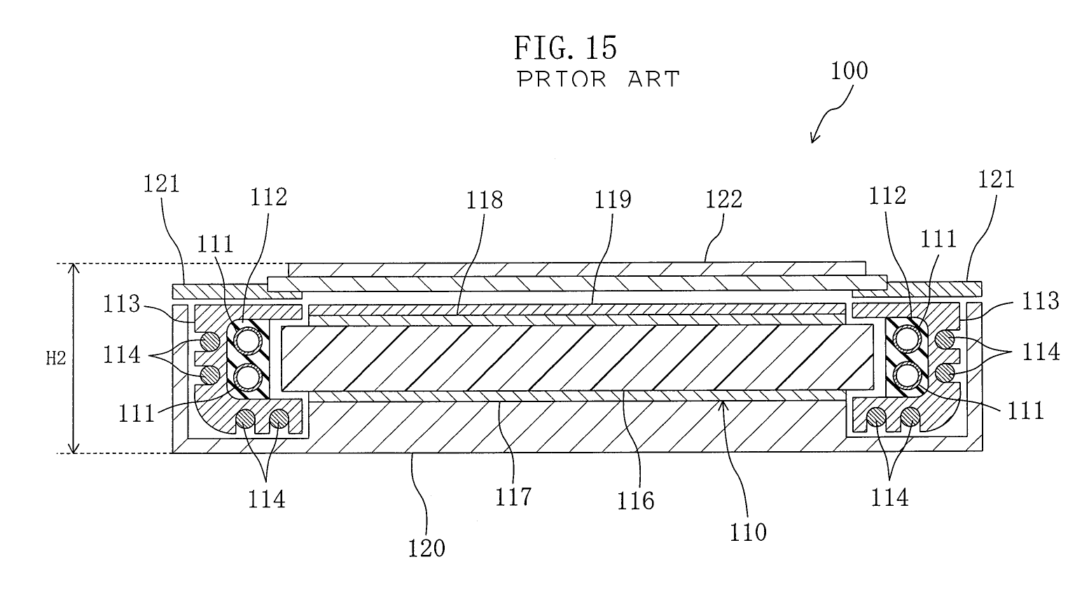

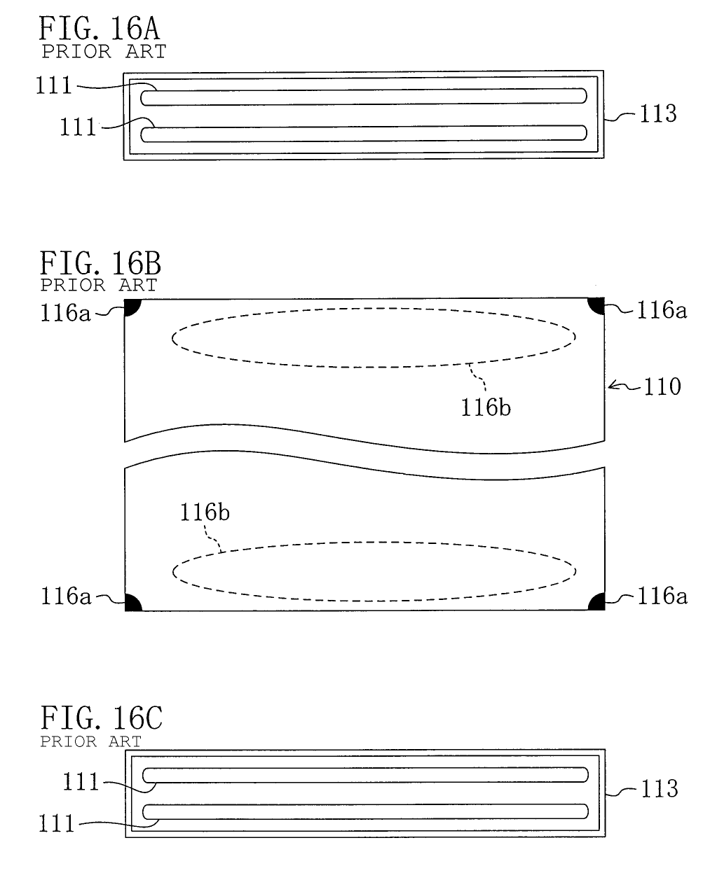

A first wire (first harness) 14a for applying a voltage to the first fluorescent tube 11a is connected to each end of the first fluorescent tube 11a, while a second wire (second harness) 14b for applying a voltage to the second fluorescent tube 11b is connected to each end of the second fluorescent tube 11b. The first and second wires 14a and 14b are routed toward the liquid crystal display panel 22 and tucked in a recess formed in the lamp holder 13 near the liquid crystal display panel 22. Therefore, the thickness (H1) of the liquid crystal display device 1 is smaller than the thickness (H2, see FIG. 15) of a conventional liquid crystal display device 100 in which the first and second wires 14a and 14b are routed toward the back surface of the light guide 16 (to the bottom in FIG. 1). Thus, the liquid crystal display device 1 is thinned down.

In the first preferred embodiment, the first wire 14a electrically connected to the first fluorescent tube 11a is routed toward the second fluorescent tube 11b which is shorter than the first fluorescent tube 11a. Therefore, frame narrowing of the backlight 10 and the liquid crystal display device 1 is achieved.

FIG. 3 is a sectional view illustrating the structure including the first and second fluorescent tubes of the same length and the first wire routed toward the second fluorescent tube.

With the structure shown in FIG. 3, first, the first wire is drawn to the extending direction of the first fluorescent tube (lengthwise direction). Then, it is routed toward the second fluorescent tube. Therefore, in the liquid crystal display device shown in FIG. 3, the width (W2) of a frame is large. In the liquid crystal display device 1 of the first preferred embodiment shown in FIG. 2, the second fluorescent tube 11b is shorter than the first fluorescent tube 11a. Therefore, the first wire 14a is routed directly toward the second fluorescent tube 11b. As a result, the width (W1) of the frame of the liquid crystal display device 1 is smaller than the width (W2) of the frame of the liquid crystal display device shown in FIG. 3.

Now, referring to FIGS. 1 and 2, the structure of the first light source 11 is explained in detail. The first light source includes the first and second fluorescent tubes 11a and 11b. Each of the first and second fluorescent tubes 11a and 11b is narrow and emits linear light (more specifically, light in the form of a linear segment). The second and first fluorescent tubes 11b and 11a are arranged substantially parallel to each other. The second and first fluorescent tubes 11b and 11a are arranged in the thickness direction of the light guide 16. The first and second fluorescent tubes 11a and 11b are different from each other in length in the lengthwise direction. More specifically, the length of the second fluorescent tube 11b in the lengthwise direction (in the extending direction of the second fluorescent tube 11b) is shorter than that of the first fluorescent tube 11a. Further, the center of the second fluorescent tube 11b in the lengthwise direction and that of the first fluorescent tube 11a are almost aligned with each other. Therefore, the ends of the second fluorescent tube 11b are positioned more inside than the ends of the first fluorescent tube 11a.

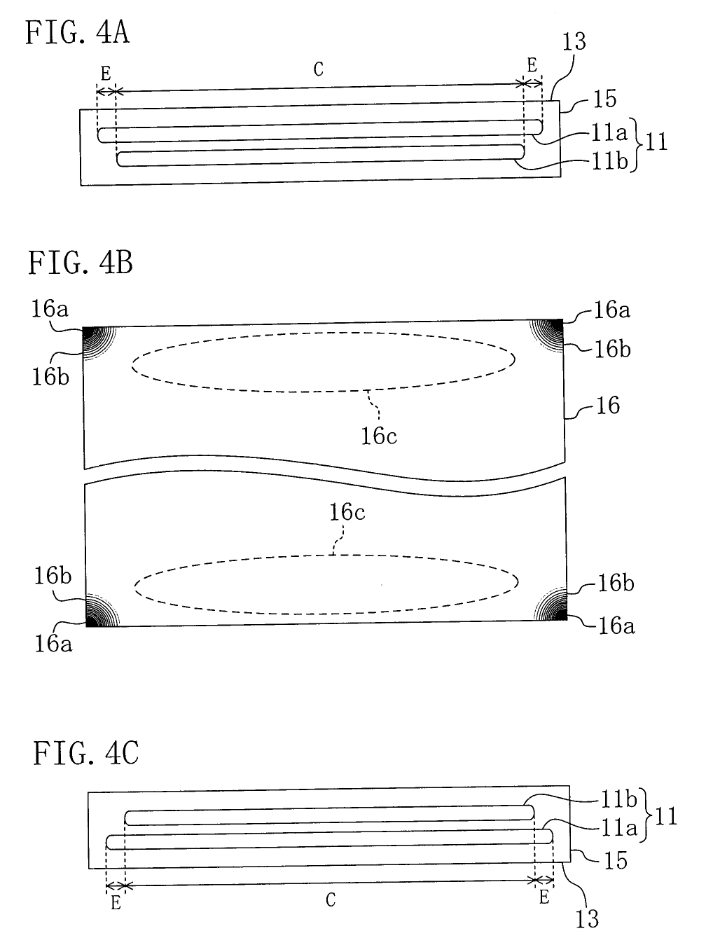

FIGS. 4A to 4C are diagrams illustrating a distribution of luminance of the backlight 10. More specifically, FIGS. 4A and 4C are diagrams of the backlight 10 viewed from the side and FIG. 4B is a diagram of the backlight 10 viewed from the principle surface (light emitting surface).

As shown in FIGS. 4A to 4C, ends E of the first light source 11 where only the first fluorescent tube 11a exists is lower in luminance than a center portion C of the first light source 11 where both of the first and second fluorescent tubes 11a and 11b exist. Therefore, corners 16a of the light guide 16 to which light from the first light source 11 does not directly enter shows the lowest luminance, while a center portion 16c of the light guide 16 to which light of the highest luminance from the center portion C of the first light source 11 enters shows the highest luminance. Portions 16b between the corners 16a and the center portion 16c to which light from the ends E of the first light source 11 enters show luminance intermediate between the luminance of the corners 16a and that of the center portion 16c. In other words, the corners 16a with the lowest luminance, the portions 16b with the intermediate luminance and the center portion 16c with the highest luminance are arranged sequentially in this order to cause gradation from the corners 16a to the center portion 16c. Therefore, the backlight 10 emits high quality planar light with less noticeable luminance variations. Thus, the liquid crystal display device 1 according to the first preferred embodiment produces high quality image with less noticeable luminance variations.

In the first preferred embodiment, the second fluorescent tube 11b which is relatively shorter than the first fluorescent tube 11a in the lengthwise direction is preferably arranged closer to the liquid crystal display panel 22 than the first fluorescent tube 11a. However, the present invention is not limited thereto. For example, the first fluorescent tube 11a relatively longer in the lengthwise direction may be arranged closer to the liquid crystal display panel 22 than the second fluorescent tube 11b. Even with this configuration, the high quality planar light with less noticeable luminance variations is obtained.

The first light source 11 may further include one or more fluorescent tubes in addition to the first and second fluorescent tubes 11a and 11b.

In the first preferred embodiment, the first and second fluorescent tubes 11a and 11b preferably are both linear. However, the present invention is not limited thereto. For example, each of the first and second fluorescent tubes 11a and 11b may be curved (e.g., S-shaped or W-shaped).

### Second Preferred Embodiment

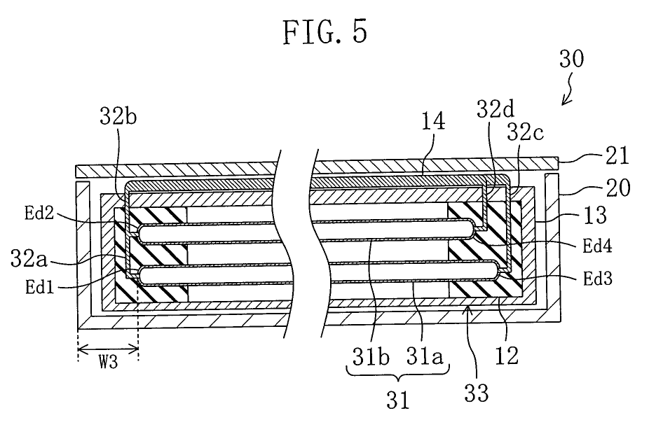

FIG. 5 is a schematic sectional view illustrating the structure of a liquid crystal display device 30 according to a second preferred embodiment of the present invention.

The liquid crystal display device 30 according to the second preferred embodiment preferably is configured in the same manner as the liquid crystal display device 1 of the first preferred embodiment except for the structure of the first light source. Hereinafter, the structure of the first light source 31 according to the second preferred embodiment is described in detail with reference to FIG. 5. In the description of the second preferred embodiment, components having substantially the same functions as those of the components of the first preferred embodiment are indicated by the same reference numerals to omit overlapping explanation.

In the liquid crystal display device 30 according to the second preferred embodiment, the first light source 31 includes a first fluorescent tube 31a and a second fluorescent tube 31b. The first fluorescent tube 31a is longer than the second fluorescent tube 31b in the lengthwise direction. In the second preferred embodiment, the first and second fluorescent tubes 31a and 31b are arranged such that an end Ed1 of the first fluorescent tube 31a is aligned with an end Ed2 of the second fluorescent tube 31b in the extending direction of the first fluorescent tube 31a (lengthwise direction), while an end Ed3 of the first fluorescent tube 31a is misaligned with an end Ed4 of the second fluorescent tube 31b in the extending direction of the first fluorescent tube 31a (lengthwise direction).

A first wire 32a is connected to the end Ed1 of the first fluorescent tube 31a, while a second wire 32b is connected to the end Ed2 of the second fluorescent tube 31b. Further, the first wire 32a is connected to the second wire 32b. With this configuration, the width (W3) of a frame of the liquid crystal display device 30 is smaller than the width (W2) of a frame shown in FIG. 3. Thus, the frame of the liquid crystal display device 30 is narrowed. Further, since the first and second wires 32a and 32b are connected, the number of wires to be routed is reduced. Therefore, the structure of the liquid crystal display device 30 is more simplified.

The end Ed1 of the first fluorescent tube 31a and the end Ed2 of the second fluorescent tube 31b are preferably COLD ends. The COLD end is an end to which a relatively low voltage is applied. An end to which a relatively high voltage is applied is generally referred to as a HOT end.

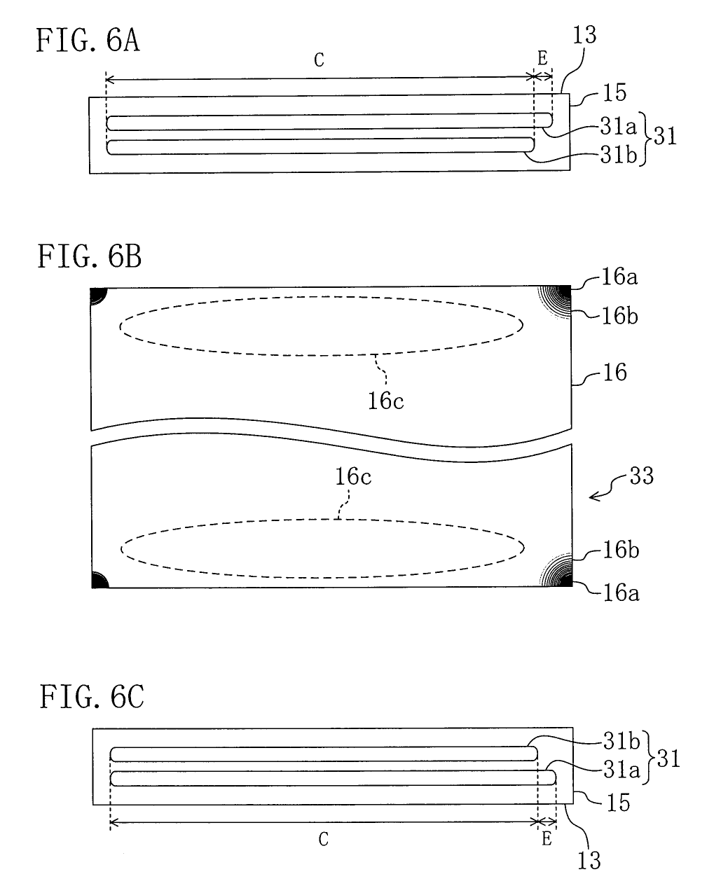

FIGS. 6A to 6C are diagrams illustrating a distribution of luminance of a backlight 33 of the liquid crystal display device 30. More specifically, FIGS. 6A and 6C are diagrams of the backlight 33 viewed from the side and FIG. 6B is a diagram of the backlight 33 viewed from the principle surface (light emitting surface).

As described above, the end Ed1 and the end Ed2 are aligned in the extending direction of the first fluorescent tube 31a, while the end Ed3 and the end Ed4 are misaligned in the extending direction of the first fluorescent tube 31a. In the second preferred embodiment, each of the ends E of the first light source 31 is constituted of the first fluorescent tube 31a only. Therefore, the luminance of the ends E of the first light source 31 is lower than that of the center portion C of the first light source 31 where both of the first and second fluorescent tubes 31a and 31b exist. Accordingly, corners 16a with low luminance to which light from the first and second fluorescent tubes 31a and 31b does not directly enter, portions 16b with intermediate luminance to which light from the ends E of the first light source 31 directly enters and a high luminance center portion 16c to which light from the center portion C of the first light source 31 directly enters are arranged sequentially in this order to cause gradation. As a result, the backlight 33 emits high quality planar light with less noticeable luminance variations at the corners 16a. Thus, the liquid crystal display device 30 according to the second preferred embodiment produces high quality image with less noticeable luminance variations.

### Third Preferred Embodiment

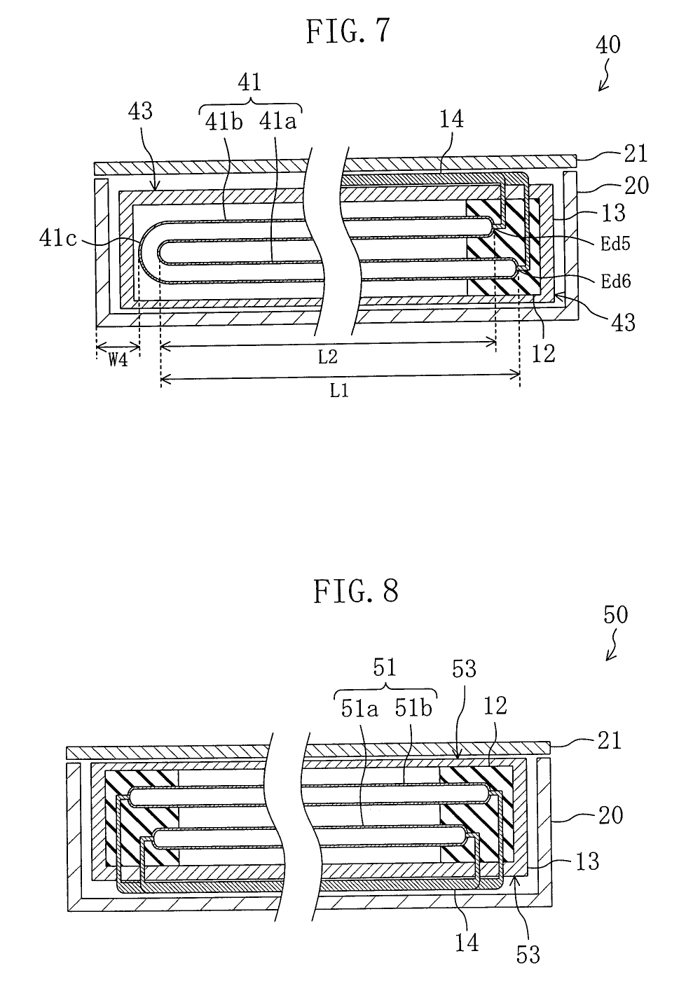

FIG. 7 is a schematic sectional view illustrating the structure of a liquid crystal display device 40 according to a third preferred embodiment of the present invention.

The liquid crystal display device 40 according to the third preferred embodiment preferably is configured in the same manner as the liquid crystal display device 30 of the second preferred embodiment except for the structure of the first light source. Hereinafter, the structure of the first light source 41 according to the third preferred embodiment is explained in detail with reference to FIG. 7. In the description of the third preferred embodiment, components having substantially the same functions as those of the components of the first and second preferred embodiments are indicated by the same reference numerals to omit overlapping explanation.

In the liquid crystal display device 40 according to the third preferred embodiment, the first light source 41 includes a first narrow fluorescent tube 41a and a second narrow fluorescent tube 41b. The first and second fluorescent tubes 41a and 41b emit linear light, respectively. The first and second fluorescent tubes 41a and 41b are coupled by a curved portion 41c. That is, the first light source 41 is U-shaped. Therefore, in the liquid crystal display device 40 of the third preferred embodiment, there is no need to electrically connect a wire to one of the ends of the first light source 41 (the end provided with the curved portion 41c). In the thus-configured liquid crystal display device 40, the width (W4) of the frame is reduced to a further extent.

The length (L2) of the second fluorescent tube 41b in the lengthwise direction is shorter than the length (L1) of the first fluorescent tube 41a in the lengthwise direction. Therefore, one of the ends of the first light source 41 is constituted of the first fluorescent tube 41a only. Luminance of this end is lower than that of the center portion of the first light source 41 constituted of the first and second fluorescent tubes 41a and 41b. Therefore, just like in the liquid crystal display device 30 of the second preferred embodiment, the luminance variations at one of the ends of the backlight 43 are less noticeable (the same effect as that shown in FIGS. 6A-6C is obtained). Therefore, the backlight 43 emits high quality planar light with relatively less noticeable luminance variations. Thus, the liquid crystal display device 40 according to the third preferred embodiment produces high quality image with relatively less noticeable luminance variations.

### Fourth Preferred Embodiment

FIG. 8 is a schematic sectional view illustrating the structure of a liquid crystal display device 50 according to a fourth preferred embodiment of the present invention.

The liquid crystal display device 50 according to the fourth preferred embodiment preferably is configured in the same manner as the liquid crystal display device 1 of the first preferred embodiment except the structure of the first light source. Hereinafter, the structure of the first light source 51 is explained in detail with reference to FIG. 8. In the description of the fourth preferred embodiment, components having substantially the same functions as those of the components of the first preferred embodiment are indicated by the same reference numerals to omit overlapping explanation.

In the liquid crystal display device 50 of the fourth preferred embodiment, the first light source 51 includes a first narrow fluorescent tube 51a and a second narrow fluorescent tube 51b. The second fluorescent tube 51b arranged closer to the liquid crystal display panel 22 is longer than the first fluorescent tube 51a in the lengthwise direction. Wires 52 connected to the first and second fluorescent tubes 51a and 51b are routed to the direction opposite the liquid crystal display panel 22 (to the bottom in FIG. 8).

Also in the fourth preferred embodiment, the center portion of the first light source 51 is constituted of the first and second fluorescent tubes 51a and 51b and both ends of the first light source 51 are constituted of the second fluorescent tube 51b only. Therefore, luminance of the ends of the first light source 51 is lower than that of the center portion of the first light source 51. That is, just like the backlight 10 of the first preferred embodiment, a backlight 53 according to the fourth preferred embodiment emits high quality planar light with less noticeable luminance variations. Therefore, just like the liquid crystal display device 1 of the first preferred embodiment (see FIG. 4B), the liquid crystal display device 50 of the fourth preferred embodiment produces high quality image with less noticeable luminance variations.

### Fifth Preferred Embodiment

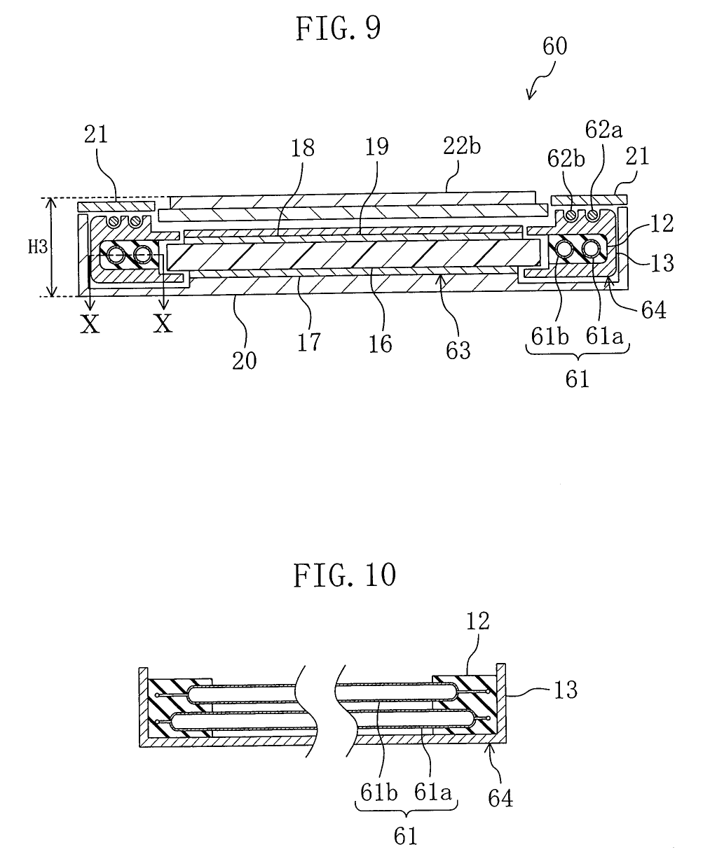

FIG. 9 is a schematic sectional view illustrating the structure of a liquid crystal display device 60 according to a fifth preferred embodiment of the present invention.

FIG. 10 is a schematic sectional view taken along the line X-X shown in FIG. 9.

The liquid crystal display device 60 according to the fifth preferred embodiment preferably is configured in the same manner as the liquid crystal display device 1 of the first preferred embodiment except for the structure of the first light source. Hereinafter, the structure of the first light source 61 of the fifth preferred embodiment is explained in detail with reference to the figures. In the description of the fifth preferred embodiment, components having substantially the same functions as those of the components of the first preferred embodiment are indicated by the same reference numerals to omit overlapping explanation.

In the liquid crystal display device 60 of the fifth preferred embodiment, a first fluorescent tube 61a and a second fluorescent tube 61b are arranged in the plane direction of the light guide 16. Therefore, a backlight 63 of the fifth preferred embodiment is made thinner than the backlight 10 of the first preferred embodiment. Thus, the thickness (H3) of the liquid crystal display device 60 of the fifth preferred embodiment is smaller than the thickness (H1) of the liquid crystal display device 1 of the first preferred embodiment.

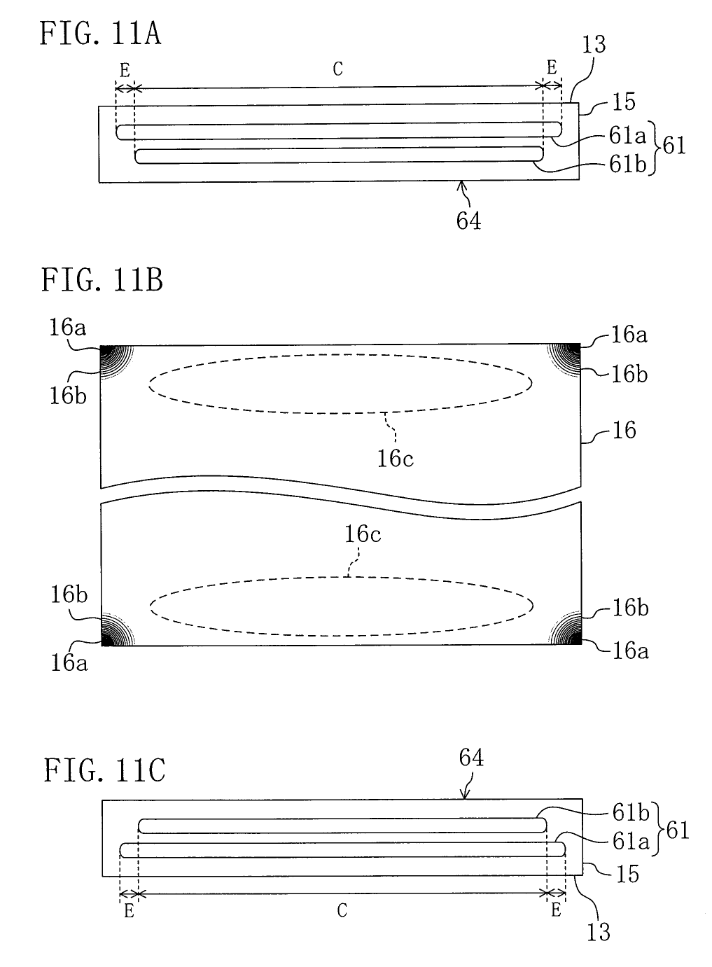

In the fifth preferred embodiment, as shown in FIG. 10, the second fluorescent tube 61b is shorter than the first fluorescent tube 61a. Therefore, the backlight 63 has a distribution of the luminance as shown in FIGS. 11A-11C.

FIGS. 11A to 11C are diagrams illustrating the distribution of the luminance of the backlight 63. More specifically, FIGS. 11A and 11C are diagrams of a light source unit 64 viewed from the principle surface (light emitting surface) of the liquid crystal display device 60 and FIG. 11B is a diagram of the light guide 16 viewed from the principle surface (light emitting surface) of the liquid crystal display device 60.

Ends E of the first light source 61 where only the first fluorescent tube 61a exists is lower in luminance than a center portion C of the first light source 61 where both of the first and second fluorescent tubes 61a and 61b exist. Therefore, corners 16a of the light guide 16 to which light from the first light source 61 does not directly enter shows the lowest luminance, while a center portion 16c of the light guide 16 to which light with the highest luminance from the center portion C of the first light source 61 enters shows the highest luminance. Portions 16b between the corners 16a and the center portion 16c to which light from the ends E of the first light source 11 directly enters show luminance intermediate between the luminance of the corners 16a and that of the center portion 16c. In other words, the corners 16a with the lowest luminance, the portions 16b with the intermediate luminance and the center portion 16c with the highest luminance are provided sequentially in this order to cause gradation from the corners 16a to the center portion 16c. Therefore, the backlight 63 emits high quality planar light with less noticeable luminance variations. Thus, the liquid crystal display device 60 according to the fifth preferred embodiment produces high quality image with less noticeable luminance variations.

### Sixth Preferred Embodiment

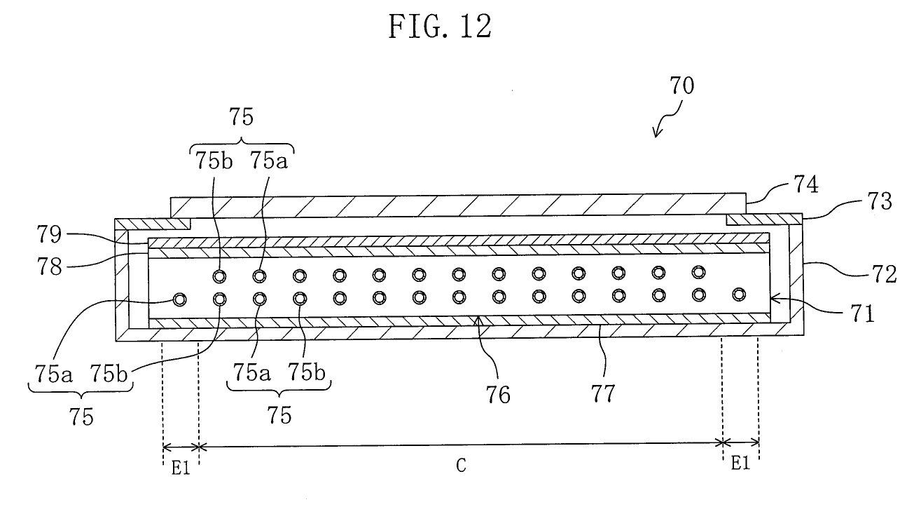

FIG. 12 is a sectional view illustrating a liquid crystal display device 70 according to a sixth preferred embodiment of the present invention.

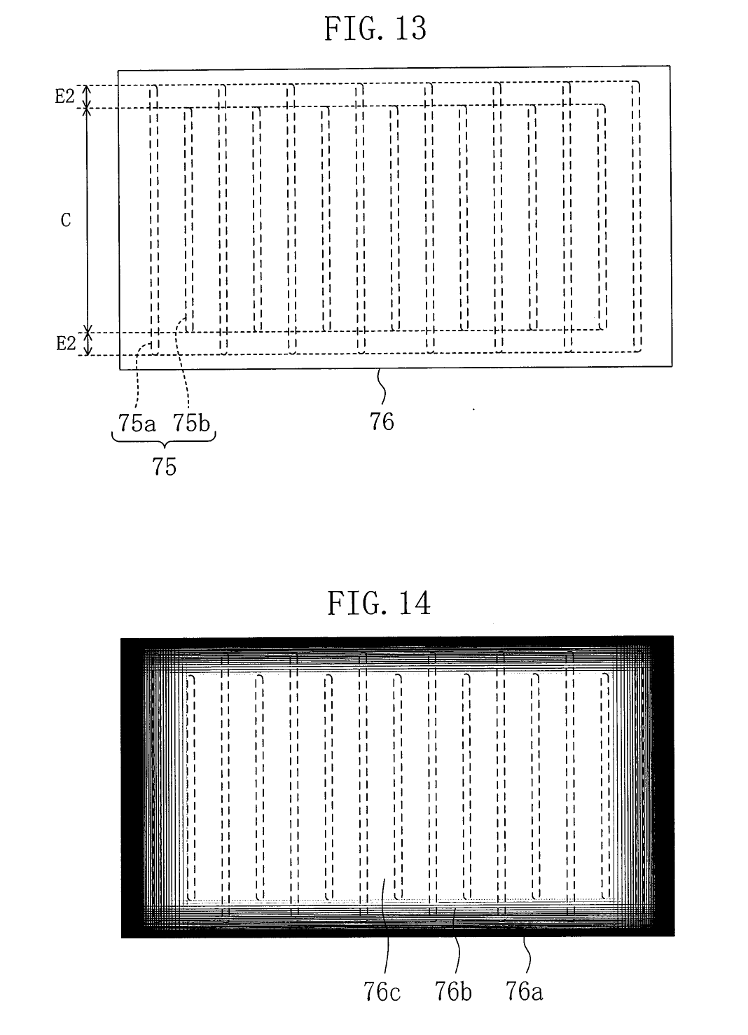

FIG. 13 is a plan view of a light source unit 76 illustrating the structure of a first light source 75.

The liquid crystal display device 70 according to the sixth preferred embodiment includes a backlight 71, a back chassis 72, a front chassis 73 and a liquid crystal display panel 74. The back chassis 72 is arranged to cover the backlight 71 from the back (from the bottom side in FIG. 12). The front chassis 73 is in the form of a frame and arranged on the periphery of the liquid crystal display device 70. The liquid crystal display panel 74 is held on the light emitting side of the backlight 71 by the front chassis 73. The liquid crystal display panel 74 includes a liquid crystal layer (not shown).

The backlight 71 includes a light source unit 76, a reflective sheet 77, a prism sheet 78 as a light emitting plate and a diffusive sheet 79. The light source unit 76 includes a plurality of first light sources 75. The reflective sheet 77 is arranged on the back surface of the light source unit 76 (bottom side in FIG. 12). The prism sheet 78 is arranged on the principle surface of the light source unit 76 (top side in FIG. 12). The diffusive sheet 79 is arranged on the prism sheet 78. Each of the first light sources 75 includes a first fluorescent tube 75a and a second fluorescent tube 75b arranged substantially parallel to the first fluorescent tube 75a.

Light emitted from the first light sources 75 is emitted, directly or after being reflected on the reflective sheet 77, out of the principle surface of the light source unit 76. The emitted light is turned to be uniform planar light by the functions of the prism sheet 78 and the diffusive sheet 79 and enters the liquid crystal display panel 74.

As shown in FIG. 12, each end E1 of the light source unit 76 includes a single first fluorescent tube 75a. In a center portion c of the light source unit 76, two first fluorescent tubes 75a or two second fluorescent tubes 75b are arranged in the stacking direction of the panel (vertical direction in FIG. 12). As shown in FIG. 13, the second fluorescent tube 75b is shorter than the first fluorescent tube 75a in the lengthwise direction. The first light sources 75 are configured such that the first and second fluorescent tubes 75a and 75b are arranged in an alternate manner. Therefore, the backlight 71 has a distribution of luminance as shown in FIG. 14.

FIG. 14 is a diagram illustrating the distribution of luminance of the backlight 71.

As shown in FIG. 14, in the backlight 71, a periphery 76a where the first light sources 75 do not exist shows the lowest luminance. A center portion 76c where two first light sources 75 are arranged in the stacking direction of the panel (thickness direction) and both of the first and second fluorescent tubes 75a and 75b exist shows the highest luminance. Then, a portion having intermediate luminance between the luminance of the periphery 76a and the luminance of the center portion 76c is formed between the periphery 76a and the center portion 76c. The portion between the periphery 76a and the center portion 76c is a portion where either one of the first and second fluorescent tubes 75a and 75b exists (E1 in FIG. 12 or E2 in FIG. 13). In other words, the periphery 76a with the lowest luminance, the portion 76b with the intermediate luminance and the center portion 76a with the highest luminance are sequentially formed in this order to cause gradation from the periphery 76a to the center portion 76c. With this configuration, the backlight 71 emits high quality planar light with less noticeable luminance variations. Thus, the liquid crystal display device 70 of the sixth preferred embodiment produces high quality image with less noticeable luminance variations.

Each pair of the first and second fluorescent tubes 75a and 75b arranged adjacent to each other in the plane direction of the backlight 71 may be coupled to be U-shaped.

As described above, the backlight according to various preferred embodiments of the present invention is able to emit high quality planar light with less noticeable luminance variations. The backlight according to the preferred embodiments of the present invention is useful for mobile (laptop) computers, cellular phones, PDAs, television sets, electrical books, monitors, electrical posters, clocks, electrical bin tags, emergency lights and the like.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-19. (canceled)

20. A backlight comprising:
at least one first light source; and
a light emitting plate arranged to receive light from the at least one first light source on a side surface thereof and to emit planar light from a principle surface thereof substantially perpendicular to the side surface; wherein
each of the at least one first light source includes a first elongated light emitting member and a second elongated light emitting member being arranged substantially parallel to the first light emitting member and different in length in the lengthwise direction from the first light emitting member.

21. The backlight of claim 20, further comprising a wire connected to an end of the first light emitting member to apply a voltage to the first light emitting member, wherein the first light emitting member is longer than the second light emitting member in the lengthwise direction and the wire is routed toward the second light emitting member.

22. The backlight of claim 20, further comprising at least one second light source including a third elongated light emitting member and a fourth elongated light emitting member being arranged substantially parallel to the third light emitting member and different in length in the lengthwise direction from the third light emitting member, the at least one second light source being arranged to emit light to a side surface of the light emitting plate opposite to the side surface receiving the light from the at least one first light source.

23. The backlight of claim 20, wherein the first light emitting member is arranged such that one end of the first light emitting member and one end of the second light emitting member are aligned in an extending direction of the first light emitting member and the other end of the first light emitting member and the other end of the second light emitting member are misaligned in the extending direction of the first light emitting member.

24. The backlight of claim 23, further comprising first wires connected to the ends of the first light emitting member to apply a voltage to the first light emitting member, and second wires connected to the ends of the second light emitting member to apply a voltage to the second light emitting member, wherein the first wire connected to the one end of the first light emitting member and the second wire connected to the one end of the second light emitting member are connected to each other.

25. The backlight of claim 23, wherein an end of the first light emitting member and an end of the second light emitting member are coupled to each other such that the first light source is substantially U-shaped.

26. The backlight of claim 20, wherein the first light emitting member and the second light emitting member are arranged in the thickness direction of the light emitting plate.

27. The backlight of claim 20, wherein the first light emitting member and the second light emitting member are arranged in the plane direction of the light emitting plate.

28. A backlight comprising:
at least one first light source; and
a light emitting plate arranged to receive light from the at least one first light source on a back surface thereof and to emit planar light from a principle surface thereof opposite to the back surface; wherein
each of the at least one first light source includes a first elongated light emitting member and a second elongated light emitting member being arranged substantially parallel to the first light emitting member and different in length in the lengthwise direction from the first light emitting member.

29. The backlight of claim 28, wherein the first light emitting member is arranged such that one end of the first light emitting member and one end of the second light emitting member are aligned in an extending direction of the first light emitting member and the other end of the first light emitting member and the other end of the second light emitting member are misaligned in the extending direction of the first light emitting member.

30. The backlight of claim 29, further comprising first wires connected to the ends of the first light emitting member to apply a voltage to the first light emitting member, and second wires connected to the ends of the second light emitting member to apply a voltage to the second light emitting member, wherein the first wire connected to the one end of the first light emitting member and the second wire connected to the one end of the second light emitting member are connected to each other.

31. The backlight of claim 28, wherein an end of the first light emitting member and an end of the second light emitting member are coupled to each other such that the first light source is substantially U-shaped.

32. The backlight of claim 28, wherein the first light emitting member and the second light emitting member are arranged in the thickness direction of the light emitting plate.

33. The backlight of claim 28, wherein the first light emitting member and the second light emitting member are arranged in the plane direction of the light emitting plate.

34. A display device comprising:
a backlight arranged to emit planar light; and
a display medium layer through which the planar light transmits; wherein
the backlight includes at least one first light source and a light emitting plate arranged to receive light from the at least first light source on a side surface thereof and to emit the planar light from a principle surface thereof substantially perpendicular to the side surface; and
each of the at least one first light source includes a first elongated light emitting member and a second elongated light emitting member being arranged substantially parallel to the first light emitting member and different in length in the lengthwise direction from the first light emitting member.

35. The display device of claim 34, wherein the backlight further includes a wire connected to an end of the first light emitting member to apply a voltage to the first light emitting member, the first light emitting member is longer than the second light emitting member in the lengthwise direction and the wire is routed toward the second light emitting member.

36. The display device of claim 34, wherein the backlight further includes at least one second narrow light source including a third elongated light emitting member and a fourth elongated light emitting member being arranged substantially parallel to the third light emitting member and different in length in the lengthwise direction from the third light emitting member and so as to emit light to a side surface of the light emitting plate opposite to the side surface receiving the light from the at least one first light source.

37. The display device of claim 34, wherein the first light emitting member is arranged such that one end of the first light emitting member and one end of the second light emitting member are aligned in an extending direction of the first light emitting member and the other end of the first light emitting member and the other end of the second light emitting member are misaligned in the extending direction of the first light emitting member.

38. The display device of claim 37, wherein the backlight further includes first wires connected to the ends of the first light emitting member to apply a voltage to the first light emitting member and second wires connected to the ends of the second light emitting member to apply a voltage to the second light emitting member, and the first wire connected to the one end of the first light emitting member and the second wire connected to the one end of the second light emitting member are connected to each other.

39. The display device of claim 34, wherein an end of the first light emitting member and an end of the second light emitting member are coupled to each other such that the first light source is substantially U-shaped.

40. The display device of claim 34, wherein the first light emitting member and the second light emitting member are arranged in the thickness direction of the light emitting plate.

41. The display device of claim 34, wherein the first light emitting member and the second light emitting member are arranged in the plane direction of the light emitting plate.

42. The display device of claim 34, wherein the display medium layer is a liquid crystal layer.

43. A display device comprising:
a backlight arranged to emit planar light; and
a display medium layer through which the planar light transmits; wherein
the backlight includes at least one first light source and a light emitting plate arranged to receive light from the at least one first light source on a back surface thereof and to emit the planar light from a principle surface thereof opposite to the back surface; and
each of the at least one first light source includes a first elongated light emitting member and a second elongated light emitting member being arranged substantially parallel to the first light emitting member and different in length in the lengthwise direction from the first light emitting member.
